(19) United States
(12) Patent Application Publication
(10) Pub. No.: US 2026/0084687 A1
(43) Pub. Date: Mar. 26, 2026

(54) CONTROL DEVICE FOR VEHICLE

(71) Applicant: TOYOTA JIDOSHA KABUSHIKI KAISHA, Toyota-shi (JP)

(72) Inventors: Takahiro KIMURA, Tajimi-shi (JP); Shota INAGAKI, Okazaki-shi (JP); Akihito HAYASAKA, Nisshin-shi (JP)

(73) Assignee: TOYOTA JIDOSHA KABUSHIKI KAISHA, Tokyo-shi (JP)

(21) Appl. No.: 19/198,438

(22) Filed: May 5, 2025

(30) Foreign Application Priority Data
Sep. 24, 2024 (JP) 2024-165677

(51) Int. Cl. B60W 20/16; B60K 6/387; B60K 6/40; B60W 10/02; B60W 10/06; B60W 10/08; B60W 20/40; F01N 9/00

(52) U.S. Cl. CPC B60W 20/16; B60K 6/387; B60K 6/40; B60W 10/026; B60W 10/06; B60W 10/08; B60W 20/40; F01N 9/002; B60W 2510/0208; B60W 2510/0241; B60W 2510/0291; B60W 2510/1005; B60W 2530/12; B60W 2710/021; B60W 2710/0627; B60Y 2200/92; B60Y 2400/426; F01N 2900/10

(57) ABSTRACT

When there is a request for regeneration control of the filter by fuel cut to the engine, regeneration control is performed in an engaged state of the direct coupling clutch. When it is impossible to bring the direct coupling clutch into an engaged state when there is a request for regeneration control, the regeneration control is performed while the rotation of the engine is assisted by the electric motor in the released state of the direct coupling clutch. In addition, in a predetermined state in which a shock due to a rotational fluctuation of the electric motor is likely to occur, the regeneration control accompanied by the rotation assistance of the engine by the electric motor is not performed. Therefore, it is possible to achieve both the suppression of the occurrence of shock caused by the rotation fluctuation of the electric motor and the regeneration of the filter.

### CROSS-REFERENCE TO RELATED APPLICATION

This application claims priority to Japanese Patent Application No. 2024-165677 filed on Sep. 24, 2024. The disclosure of the above-identified application, including the specification, drawings, and claims, is incorporated by reference herein in its entirety.

### BACKGROUND

### 1. Technical Field

The present disclosure relates to a control device for a vehicle including a filter that collects particulate matter contained in exhaust gas of an engine.

### 2. Description of Related Art

A control device for a vehicle including a power source, a fluid transmission device, a direct coupling clutch, and a filter is well known. The power source includes an engine and an electric motor. The fluid transmission device is provided in a power transmission path between the power source and drive wheels. The direct coupling clutch couples an input member and an output member of the fluid transmission device. The filter collects particulate matter contained in exhaust gas of the engine. A hybrid electric vehicle described in Japanese Unexamined Patent Application Publication No. 2024-66865 (JP 2024-66865 A) is an example. JP 2024-66865 A discloses that, when a request is made for regeneration control on the filter by a fuel cut for the engine and the direct coupling clutch cannot be engaged, the regeneration control is performed while the rotation of the engine is assisted by the electric motor with the direct coupling clutch disengaged.

### SUMMARY

When the regeneration control is performed while the rotation of the engine is assisted by the electric motor, the rotation fluctuation of the engine, that is, the rotation fluctuation of the electric motor, may lead to a shock.

The present disclosure has been made in view of the above circumstances, and an object of the present disclosure is to provide a control device for a vehicle that can achieve both suppression of a shock due to a rotation fluctuation of an electric motor and regeneration of a filter.

The gist of a first aspect of the disclosure is (a) a control device for a vehicle including a power source including an engine and an electric motor, a fluid transmission device provided in a power transmission path between the power source and a drive wheel, a direct coupling clutch that couples an input member and an output member of the fluid transmission device, and a filter that collects particulate matter contained in exhaust gas of the engine.

(b) The control device includes a regeneration control unit configured to:
when a request is made for regeneration control for regenerating the filter to burn and remove the particulate matter collected on the filter by a fuel cut for stopping fuel supply to the engine, perform the regeneration control in an engaged state of the direct coupling clutch; and
when the request is made for the regeneration control and the engaged state of the direct coupling clutch is not achievable, perform the regeneration control while rotation of the engine is assisted by the electric motor in a disengaged state of the direct coupling clutch. (c) The regeneration control unit is configured not to perform the regeneration control involving rotation assistance for the engine by the electric motor in a predetermined state in which a shock due to a rotation fluctuation of the electric motor is likely to occur.

According to the first aspect of the disclosure, when the request is made for the regeneration control on the filter by the fuel cut for the engine, the regeneration control is performed in the engaged state of the direct coupling clutch. When the request is made for the regeneration control and the engaged state of the direct coupling clutch is not achievable, the regeneration control is performed while the rotation of the engine is assisted by the electric motor in the disengaged state of the direct coupling clutch. In addition, the regeneration control involving the rotation assistance for the engine by the electric motor is not performed in the predetermined state in which a shock due to the rotation fluctuation of the electric motor is likely to occur. Therefore, it is possible to achieve both the suppression of the shock due to the rotation fluctuation of the electric motor and the regeneration of the filter.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining a schematic configuration of a vehicle to which the present disclosure is applied, and is a diagram for explaining a control function for various controls in a vehicle and a main part of a control system; and

FIG. 2 is a flow chart for explaining a main part of a control operation of the electronic control device, and is a flow chart for explaining a control operation for achieving both suppression of generation of shocks caused by rotational variation of the electric motor and regeneration of GPF.

### DETAILED DESCRIPTION OF EMBODIMENTS

Hereinafter, examples of the present disclosure will be described in detail with reference to the drawings.

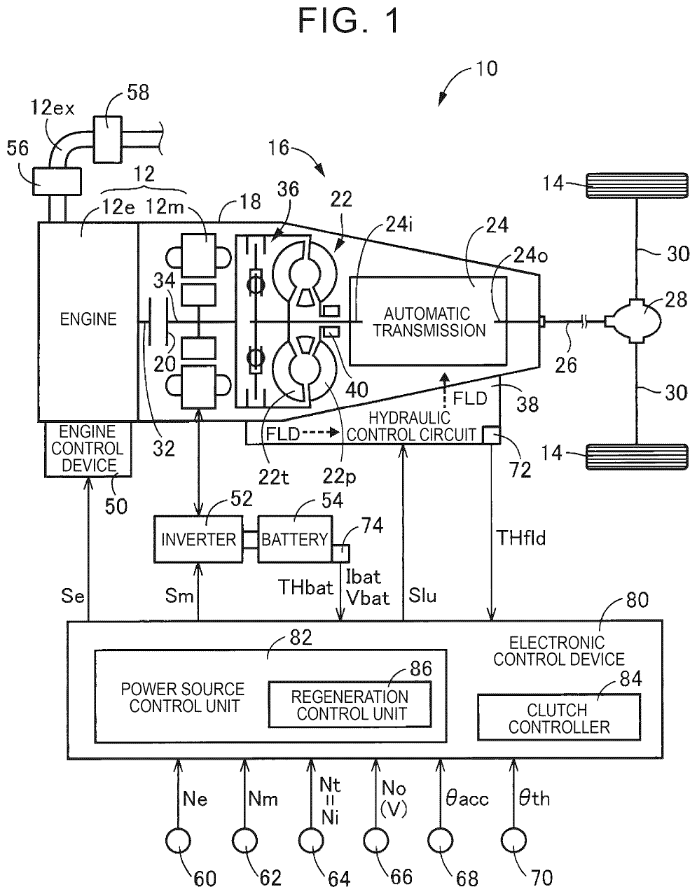

FIG. 1 is a diagram illustrating a schematic configuration of a vehicle 10 to which the present disclosure is applied, and is a diagram illustrating control functions and a main part of a control system for various controls in the vehicle 10. In FIG. 1, a vehicle 10 is a hybrid electric vehicle including an engine 12e and an electric motor 12m functioning as a power source 12. Further, the vehicle 10 includes a drive wheel 14 and a power transmission device 16 provided in a power transmission path between the power source 12 and the drive wheel 14.

An engine 12e is a known internal combustion engine that generates power by burning fuel, for example, a gasoline engine that uses gasoline as fuel. In the engine 12e, an engine control device 50 including an electronic throttle valve, a fuel injection device, an ignition device, and the like provided in the vehicle 10 is controlled by an electronic control device 80 to be described later to control an engine torque Te which is a torque of an engine 12e.

The electric motor 12m is a rotating electric machine having a function as an engine for generating mechanical power from electric power and a function as a generator for generating electric power from mechanical power, and is a so-called motor generator. The electric motor 12m is connected to a battery 54 provided in the vehicle 10 via an inverter 52 provided in the vehicle 10. The battery 54 is a power storage device that transmits and receives electric power to and from the electric motor 12m. In the electric motor 12m, MG torque Tm, which is the torque of the electric motor 12m, is controlled by controlling the inverters 52 by an electronic control device 80, which will be described later. MG torque Tm is, for example, a power running torque at a positive torque on the acceleration side and a regenerative torque at a negative torque on the deceleration side when the rotational direction of the electric motor 12m is the same rotational direction as that at the time of the operation of the engine 12e. The electric power is also synonymous with electric energy unless otherwise distinguished. The power is synonymous with the driving force, the torque, and the force unless otherwise specified.

The power transmission device 16 includes a K0 clutch 20, a torque converter 22, an automatic transmission 24, and the like in a case 18 that is a non-rotating member attached to a vehicle body. K0 clutch 20 is a clutch provided between the engine 12e and the electric motor 12m in a power transmission path between the engine 12e and the drive wheels 14. The torque converter 22 is coupled to the engine 12e via a K0 clutch 20. The automatic transmission 24 is connected to the torque converter 22, and is a transmission provided in a power transmission path between the torque converter 22 and the drive wheels 14. The power transmission device 16 includes a propeller shaft 26 connected to the transmission output shaft 24o, a differential gear 28 connected to the propeller shaft 26, a pair of drive shafts 30 connected to the differential gear 28, and the like. The transmission output shaft 24o is an output rotating member of the automatic transmission 24. Further, the power transmission device 16 includes, in the case 18, an engine coupling shaft 32 that couples the engine 12e and K0 clutch 20, an electric motor coupling shaft 34 that couples K0 clutch 20 and the torque converter 22, and the like.

The electric motor 12m is coupled to the electric motor coupling shaft 34 in the case 18 so as to be capable of transmitting power. That is, the electric motor 12m is connected to a power transmission path between the engine 12e and the drive wheels 14, in particular, to a power transmission path between K0 clutch 20 and the torque converter 22. In other words, the electric motor 12m is connected to the torque converter 22 and the automatic transmission 24 so as to be able to transmit power without passing through K0 clutches 20.

The torque converter 22 includes a pump impeller 22p coupled to the electric motor coupling shaft 34 and a turbine impeller 22t coupled to the transmission-input shaft 24i. The transmission input shaft 24i is an input rotating member of the automatic transmission 24. The pump impeller 22p is an input member of the torque converter 22, and the turbine impeller 22t is an output member of the torque converter 22. The torque converter 22 is a fluid transmission device provided in a power transmission path between the power source 12 and the drive wheels 14. The torque converter 22 transmits the power from the power source 12 from the electric motor coupling shaft 34 to the transmission input shaft 24i via a fluid.

The torque converter 22 includes an LU clutch 36 as a direct coupling clutch that connects the pump impeller 22p and the turbine impeller 22t. LU clutch 36 is a known lock-up clutch, for example, a hydraulic frictional engagement device. The control status of LU clutch 36 is switched by changing LU torque Tlu which is the torque capacitance of the LU clutch 36 by LU hydraulic pressure PRlu. LU hydraulic pressure PRlu is a regulated hydraulic pressure supplied to LU clutch 36 from the hydraulic control circuit 38 provided in the vehicle 10.

The control states of LU clutch 36 include a release state (the fully released state is synonymous), a slip state in which LU clutch 36 is engaged with a slip, and an engagement state (the fully engaged state is synonymous). When LU clutch 36 is released, the torque converter 22 is brought into a torque converter state in which a torque amplifying action is obtained. In addition, when LU clutch 36 is brought into an engaged state, the torque converter 22 is brought into a lock-up state (also referred to as a complete lock-up state) in which the pump impeller 22p and the turbine impeller 22t are integrally rotated.

The automatic transmission 24 is, for example, a known planetary gear type automatic transmission. In the automatic transmission 24, any one of a plurality of gear stages (gear stages are also synonymous) having different gear ratios (gear ratios are also synonymous) γ (=Ni/No) is formed in accordance with an accelerator operation of a driver, a vehicle speed V, and the like. “Ni” is a signal representing the rotation speed of the transmission input shaft 24i, and represents the transmission input rotation speed that is the input rotation speed of the automatic transmission 24. “No” is a signal representing the rotation speed of the transmission output shaft 24o, and represents the transmission output rotation speed that is the output rotation speed of the automatic transmission 24.

K0 clutch 20 is, for example, a hydraulic frictional engagement device constituted by a multi-plate type or single-plate type clutch. In K0 clutch 20, K0 hydraulic pressure PRk0 changes K0 torque Tk0, which is the torque capacity of the K0 clutch 20, so that the control states such as the engagement state, the slipping state, and the release state are switched. K0 hydraulic PRk0 is the regulated hydraulic pressure supplied from the hydraulic control circuit 38 to K0 clutch 20.

K0 clutches 20 are engaged. Then, the power of the engine 12e is sequentially transmitted to the drive wheels 14 via K0 clutch 20, the torque converter 22, the automatic transmission 24, the propeller shaft 26, the differential gear 28, the drive shaft 30, and the like. The power of the electric motor 12m is transmitted to the drive wheels 14 through the torque converter 22, the automatic transmission 24, the propeller shaft 26, the differential gear 28, the drive shaft 30, and the like in order regardless of the control status of K0 clutch 20.

The vehicle 10 includes a mechanical oil pump 40. The oil pump 40 is connected to the pump impeller 22p, and is rotationally driven by a power source 12 to discharge hydraulic oil FLD used in the power transmission device 16. The hydraulic oil FLD discharged from the oil pump 40 is supplied to the hydraulic control circuit 38. The hydraulic control circuit 38 supplies LU hydraulic pressure PRlu, K0 hydraulic pressure PRk0 and the like, each of which is regulated based on the hydraulic oil FLD discharged by the oil pump 40. The hydraulic oil FLD functions as hydraulic oil supplied to LU clutch 36, hydraulic oil supplied to K0 clutch 20, and the like.

Vehicle 10 includes catalyst 56 and GPF (Gasoline Particulate Filter) 58. The catalyst 56 and GPF 58 are provided in the exhaust pipe 12ex of the engine 12e. The catalyst 56 is, for example, a known three-way catalyst for purifying hydrocarbons (HC), carbon monoxide (CO), nitrogen oxides (NOx), and the like contained in the exhaust gas of the engine 12e. GPF 58 is provided downstream of the catalyst 56. GPF 58 is a filter that collects particulate matter (PM (Particulate Matter)) contained in the exhaust of the engine 12e. By providing a GPF 58 in addition to the catalyst 56, the exhaust gas can be further purified.

The vehicle 10 further includes an electronic control device 80 as a controller including a control unit for the vehicle 10 related to the control of the engine 12e, LU clutch 36, and the like. The electronic control device 80 includes, for example, a so-called microcomputer including a CPU, RAM, ROM, an input/output interface, and the like. CPU performs various kinds of control of the vehicles 10 by performing signal-processing in accordance with a program stored in ROM in advance using, for example, a temporary storage function of RAM.

Various signals and the like based on detection signals by various sensors and the like provided in the vehicle 10 are input to the electronic control device 80. Examples of the various sensors include an engine rotation speed sensor 60, an MG rotation speed sensor 62, an input rotation speed sensor 64, an output rotation speed sensor 66, an accelerator operation amount sensor 68, and a throttle valve opening degree sensor 70. Examples of the various sensors include a hydraulic oil temperature sensor 72 and a battery sensor 74. The various types of signals are, for example, an engine rotation speed Ne, MG rotation speed Nm, a transmission input rotation speed Ni, a transmission output rotation speed No, an accelerator operation amount θacc, a throttle valve opening degree θth, and the like. Further, various types of signals and the like are, for example, a hydraulic oil temperature THfld, a battery temperature THbat, a battery charge/discharge current Ibat, a battery voltage Vbat, and the like.

The engine rotation speed Ne represents the rotation speed of the engine 12e. MG rotation speed Nm represents the rotation speed of the electric motor 12m. The transmission input rotation speed Ni is equal to the turbine rotation speed Nt, which is the output rotation speed of the torque converter 22. The transmission-output rotation speed No is a rotation speed corresponding to the vehicle speed V. The accelerator operation amount θacc is a signal representing an accelerator operation amount of the driver representing a magnitude of the acceleration operation of the driver. The throttle valve opening degree θth is a signal representing the opening degree of the electronic throttle valve. The hydraulic oil temperature THfld indicates the temperature of the hydraulic oil FLD. The battery temperature THbat indicates the temperature of the battery 54. The battery charge/discharge current Ibat is a signal representing the current charged in the battery 54 and a signal representing the current discharged from the battery 54. The battery voltage Vbat represents the voltage of the battery 54.

The electronic control device 80 calculates the remaining charge SOC [%] based on, for example, the battery charge/discharge current Ibat, the battery voltage Vbat, and the like. The remaining charge SOC is the remaining charge amount of the battery 54 and indicates the state of charge of the battery 54. The electronic control device 80 calculates the chargeable power Win [W] and the dischargeable power Wout [W] of the battery 54 based on, for example, the battery temperature THbat and the remaining charge SOC.

Various command signals and the like are output from the electronic control device 80 to each device and the like provided in the vehicle 10. Each of the devices is, for example, a hydraulic control circuit 38, an engine control device 50, an inverter 52, or the like. Examples of the various command signals include an LU hydraulic control command signal Slu and an engine control command signal Se, MG control command signal Sm. LU hydraulic control command signal Slu is a command signal for controlling LU clutch 36, and is an instruction hydraulic pressure of LU hydraulic pressure PRlu. The engine control command signal Se is a command signal for controlling the engine 12e. MG control command signal Sm is a command signal for controlling the electric motor 12m.

The electronic control device 80 includes a power source control unit 82 and a clutch control unit 84 in order to realize various kinds of control in the vehicle 10.

The power source control unit 82 calculates a drive request amount for the vehicle 10 by the driver, for example, by applying the accelerator operation amount θacc and the vehicle speed V to the drive request amount map. The drive request amount map is, for example, a relationship for determining a drive request amount which is determined and stored in advance experimentally or designically, that is, predetermined. The drive requirement is, for example, a required drive torque Trdem and a required drive force Frdem in the drive wheels 14. Power source control unit 82, so that the power source torque for realizing the drive requirement (Te+Tm) is obtained, and outputs a control command signal for controlling the power source 12 (engine control command signal Se, MG control command signal Sm). The power source torque is calculated in consideration of transmission loss, accessory load, gear ratio γ, and the like.

The clutch control unit 84 determines a control region using, for example, a predetermined lock-up region diagram. The clutch-control unit 84 outputs LU oil pressure control command Slu to the hydraulic control circuit 38. LU hydraulic control command Slu controls LU clutch 36 so that a control condition corresponding to the control area determined by the clutch control unit 84 is realized. When determining that the control region is the lock-up region, the clutch control unit 84 brings LU clutch 36 into engagement. On the other hand, when determining that the control region is the release region, the clutch control unit 84 releases LU clutch 36. On the other hand, when determining that the control region is the slip region, the clutch control unit 84 sets LU clutch 36 to the slip state.

Here, when a large amount of collected PM is deposited on GPF 58, the performance is deteriorated due to clogging or the discharge of the exhausted air is hindered. Therefore, the power source control unit 82 functionally includes a regeneration control unit 86 that performs GPF regeneration control CNgpf in order to avoid or suppress functional loss of the engine 12e due to overaccumulation of PM in GPF 58. The functional defect of the engine 12e due to the overaccumulation of PM is, for example, a decrease in the power of the engine 12e due to an increase in the pressure-loss of the exhaust gas, a deterioration in fuel consumption, and the like. GPF regeneration control CNgpf is regeneration control for regenerating GPF 58 so as to burn and remove PM collected in GPF 58. That is, GPF regeneration control CNgpf is regeneration control for regenerating GPF 58 by controlling the engine 12e so that PM collected in GPF 58 is easily burned.

The regeneration control unit 86 determines whether or not PM of a predetermined quantity Qpmf or more is accumulated in GPF 58. The regeneration control unit 86 estimates PM accumulation amount Qpm in GPF 58 based on the vehicle condition such as the travel distance of the vehicle 10, the operation time of the engine 12e, and the load of the engine 12e after the previous GPF regeneration control CNgpf is executed, for example. The regeneration control unit 86 determines, based on whether or not the deposition amount Qpm is equal to or greater than a predetermined amount Qpmf, whether or not a predetermined amount Qpmf or more of PM is deposited on GPF 58. The predetermined quantity Qpmf is, for example, a predetermined threshold for determining that the process of regenerating GPF 58 is required. Alternatively, the regeneration control unit 86 may determine whether or not PM of a predetermined quantity Qpmf or more is accumulated in GPF 58 based on whether or not the pressure difference between the upstream pressure and the downstream pressure of GPF 58 is equal to or greater than the predetermined pressure difference. The predetermined pressure difference is, for example, a predetermined threshold value for determining that the pressure difference is such that the flow of the exhaust gas is hindered and the engine performance is impaired.

When it is determined that PM of a predetermined quantity Qpmf or more is accumulated in GPF 58, the regeneration control unit 86 turns on the requesting flag of GPF regeneration control CNgpf and performs GPF regeneration control CNgpf. When it is determined that PM of a predetermined quantity Qpmf or more is not accumulated in GPF 58, the regeneration control unit 86 prohibits the demand of GPF regeneration control CNgpf and does not perform GPF regeneration control CNgpf. The regeneration control unit 86 may turn on the request flag of GPF regeneration control CNgpf even when a process of regenerating GPF 58 is requested by the driver, for example.

The regeneration control unit 86 performs GPF regeneration control CNgpf by cutting fuel that stops supplying fuel to the engine 12e in an accelerator-off condition, for example, when the required flag of GPF regeneration control CNgpf is turned on. The regeneration control unit 86 determines whether or not there is a demand for GPF regeneration control CNgpf by fuel-cutting by determining whether or not PM of a predetermined quantity Qpmf or more is accumulated in GPF 58.

In GPF regeneration control CNgpf by the fuel cut, it is desired to accelerate the burning of PM by rotating the engine 12e to GPF 58 in the fuel cut condition. Even in the fuel-cut state, if LU clutch 36 is in the engaged state, GPF 58 can be caused to flow by turning the engine 12e from the drive wheels 14.

When GPF regeneration control CNgpf by the fuel cut is required, the regeneration control unit 86 performs GPF regeneration control CNgpf by the fuel cut while LU clutch 36 is engaged. When GPF regeneration control CNgpf is required, the clutch control unit 84 determines whether or not LU clutch 36 cannot be engaged. The clutch control unit 84 determines whether or not LU clutch 36 cannot be engaged based on, for example, whether or not the hydraulic oil temperature THfld is less than the predetermined low oil temperature THfldlow. Therefore, when the hydraulic oil temperature THfld is less than the predetermined low oil temperature THfldlow, LU clutch 36 cannot be engaged. The predetermined low-oil-temperature THfldlow is, for example, a lower limit at which controllability of the engagement condition of LU clutch 36 can be secured, which is determined in advance. When determining that LU clutch 36 cannot be brought into the engaged state, the clutch control unit 84 controls LU clutch 36 to the engaged state.

When LU clutch 36 cannot be brought into the engaged state, the regeneration control unit 86 performs GPF regeneration control CNgpf by fuel-cutting in the released state of LU clutch 36 in order to increase the chance of GPF regeneration control CNgpf. Even in the open state and the fuel-cut state of LU clutch 36, GPF 58 can be caused to flow by rotating the engine 12e by the electric motor 12m.

The regeneration control unit 86 performs GPF regeneration control CNgpf by the fuel cut in the released state of LU clutch 36 while assisting the electric motor 12m in rotating the engine 12e when LU clutch 36 is disabled to be in the engaged state when there is a demand for GPF regeneration control CNgpf by the fuel cut. When determining that LU clutch 36 cannot be brought into the engaged state, the clutch control unit 84 controls LU clutch 36 to the released state. Assisting the rotation of the engine 12e by the electric motor 12m is, for example, rotationally driving the engine 12e by the electric motor 12m to keep the engine rotation speed Ne at a predetermined rotation speed suitable for GPF regeneration control CNgpf. That is, assisting the rotation of the engine 12e by the electric motor 12m is assisting the rotation of the engine 12e by the electric motor 12m and is supporting the rotation of the engine 12e by the electric motor 12m. In this embodiment, a fuel-cut GPF regeneration control CNgpf with engine 12e rotational assistance by an electric motor 12m is referred to as an GPF 58 auxiliary regeneration control, that is, a GPF assisted regeneration control CNgpfa.

When it is determined that LU clutch 36 cannot be brought into the engaged state, the regeneration control unit 86 determines whether or not the electric motor 12m can assist in rotating the engine 12e, for example, based on the state of the battery 54. The status of the battery 54 is represented by, for example, at least one of a battery temperature THbat, a battery charge/discharge current Ibat, a battery voltage Vbat, a remaining charge SOC, a chargeable power Win, and a dischargeable power Wout. For example, when the dischargeable power Wout is less than the predetermined power, the regeneration control unit 86 determines that the electric motor 12m is not capable of assisting the engine 12e in rotating. When it is determined that the electric motor 12m is not capable of assisting the engine 12e in rotating, the regeneration control unit 86 does not perform the fuel-cut GPF regeneration control CNgpf, that is, GPF assisted regeneration control CNgpfa when LU clutch 36 is released.

When GPF assisted regeneration control CNgpfa is performed, the rotational fluctuation of the engine 12e, that is, the rotational fluctuation of the electric motor 12m may be shocked. For example, in the torque converter state of the torque converter 22 and the low gear stage of the automatic transmission 24 (the large gear ratio is also synonymous), since the torque amplification amount is increased, a small amount of rotation fluctuation is likely to lead to a shock. The low gear stage of the automatic transmission 24 is, for example, a gear stage (gear ratio is also synonymous) on the low vehicle speed side in which the gear ratio γ is set to be larger than “1”.

When LU clutch 36 cannot be engaged, the regeneration control unit 86 determines whether or not the gear stage of the automatic transmission 24 is a high-gear stage (the smaller gear ratio is also synonymous). The high gear stage of the automatic transmission 24 is, for example, a gear stage on the high vehicle speed side in which the gear ratio γ is equal to or less than “1”. When the gear stage of the automatic transmission 24 is the high-gear stage, the regeneration control unit 86 permits GPF assisted regeneration control CNgpfa when LU clutch 36 is released. When the gear stage of the automatic transmission 24 is the low gear stage, the regeneration control unit 86 prohibits GPF assisted regeneration control CNgpfa when LU clutch 36 is released. That is, the regeneration control unit 86 does not perform GPF assisted regeneration control CNgpfa in the release state of LU clutch 36 in the predetermined state FS in which the gear stage of the automatic transmission 24 is the low gear stage. The predetermined state FS is, for example, a predetermined vehicle state in which shocks due to rotational variation of the electric motor 12m are likely to occur. The low gear stage and the accelerator-off state are in a low vehicle speed range in which the amount of air flowing into the vehicle 10 is reduced, and are also in a small range as the traveling area, so that the effect on the regeneration of GPF 58 is limited even if GPF assisted regeneration control CNgpfa is not performed.

The control state of LU clutch 36 may be a slipping state separately from the release state and the engagement state. Even in the slipping condition of LU clutch 36, GPF regeneration control CNgpf by the fuel-cutting is enabled. In this slipping condition, it is conceivable to perform GPF assisted regeneration control CNgpfa, but when GPF assisted regeneration control CNgpfa is performed, the electric motor 12m is likely to be shocked due to rotational variation. In the slip state, LU clutch 36 is engaged with the slip, but even in the fuel-cut state, the engine 12e can be rotated from the drive wheels 14.

When GPF regeneration control CNgpf is required, the clutch control unit 84 determines whether or not LU clutch 36 cannot be slipped. The clutch control unit 84 determines whether or not LU clutch 36 cannot be slipped based on, for example, whether or not the hydraulic oil temperature THfld is less than the predetermined high oil temperature THfldhi. Therefore, when the hydraulic oil temperature THfld is lower than the predetermined high oil temperature THfldhi, LU clutch 36 cannot be slipped. The predetermined high oil temperature THfldhi is, for example, a predetermined lower limit value at which the controllability of the slipping condition of LU clutch 36 can be ensured, which is higher than the predetermined low oil temperature THfldlow. The predetermined high oil temperature THfldhi may be, for example, a predetermined lower limit of the temperature range determined to be warm-up completed. When determining that LU clutch 36 cannot be set to the slip state, the clutch control unit 84 controls LU clutch 36 to the slip state.

When LU clutch 36 is disabled to be in the engaged state and LU clutch 36 is disabled to be in the slipped state, the regeneration control unit 86 performs GPF assisted regeneration control CNgpfa in the released state of LU clutch 36.

The regeneration control unit 86 performs GPF regeneration control CNgpf in a predetermined state FS in which LU clutch 36 is in the slip state when GPF regeneration control CNgpf by the fuel-cut is required and LU clutch 36 is in the slip state. That is, the regeneration control unit 86 performs GPF regeneration control CNgpf by fuel-cutting without assisting the electric motor 12m in rotating the engine 12e in a predetermined state FS in which LU clutch 36 is in a slipped state.

As described above, the regeneration control unit 86 does not perform GPF assisted regeneration control CNgpfa in the predetermined state FS (for example, the low gear stage of the automatic transmission 24 and the slipping state of LU clutch 36).

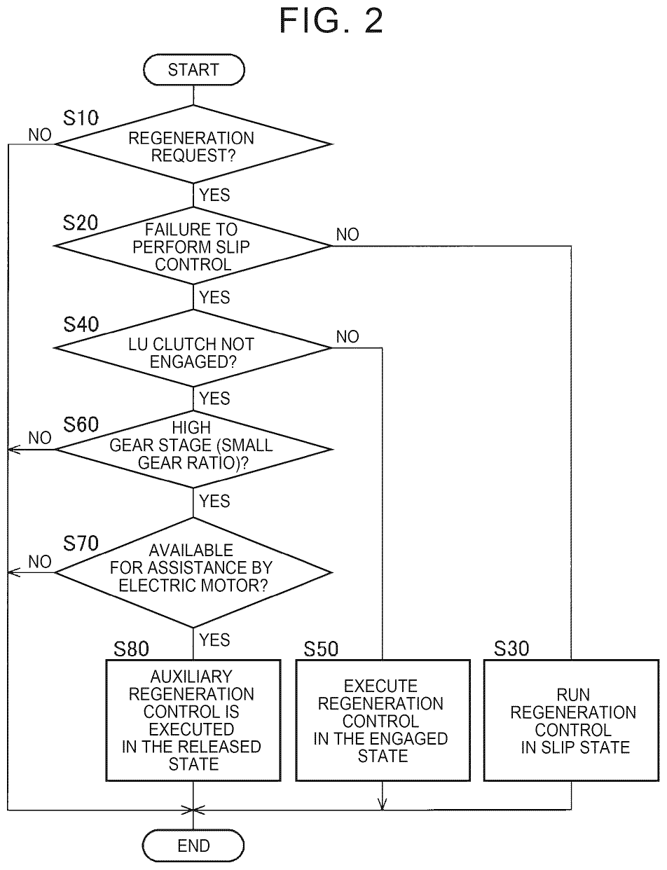

FIG. 2 is a flowchart for explaining a main part of the control operation of the electronic control device 80. FIG. 2 illustrates a control operation for achieving both suppression of generation of shocks caused by rotational variation of the electric motor 12m and regeneration of GPF 58. The control operation is repeatedly executed, for example.

In FIG. 2, first, in a step (hereinafter, step is omitted) S10 corresponding to the function of the regeneration control unit 86, it is determined whether or not there is a demand for GPF regeneration control CNgpf by fuel-cutting. If the determination of S10 is denied, this routine is terminated. When the determination of S10 is affirmative, it is determined whether or not LU clutch 36 cannot be slipped in S20 corresponding to the function of the clutch control unit 84. That is, it is determined whether or not the slipping control of LU clutch 36 cannot be performed. When the determination of S20 is negative, GPF regeneration control CNgpf is performed by the fuel-cut in the slipping condition of LU clutch 36 in S30 corresponding to the functions of the clutch control unit 84 and the regeneration control unit 86. When the determination of S20 is affirmative, it is determined whether or not LU clutch 36 cannot be engaged in S40 corresponding to the function of the clutch control unit 84. That is, it is determined whether or not LU clutch 36 cannot be engaged. When the determination of S40 is negative, GPF regeneration control CNgpf by the fuel-cut is performed in the engagement condition of LU clutch 36 in S50 corresponding to the functions of the clutch control unit 84 and the regeneration control unit 86. When the determination of S40 is affirmative, it is determined whether or not the gear stage of the automatic transmission 24 is the high gear stage in S60 corresponding to the function of the regeneration control unit 86. If the determination of this S60 is negative, the routine is terminated. When the determination of S60 is affirmative, it is determined whether or not the electric motor 12m can assist in rotating the engine 12e in S70 corresponding to the function of the regeneration control unit 86. If the determination of this S70 is negative, the routine is terminated. When the determination of S70 is affirmative, GPF assisted regeneration control CNgpfa is performed while LU clutch 36 is released in S80 corresponding to the functions of the clutch control unit 84 and the regeneration control unit 86.

As described above, according to the present embodiment, when GPF regeneration control CNgpf by the fuel cut is required, GPF regeneration control CNgpf by the fuel cut is performed while LU clutch 36 is engaged. On the other hand, when GPF regeneration control CNgpf by the fuel-cut is required, when LU clutch 36 is disabled to be in the engaged state, GPF assisted regeneration control CNgpfa of LU regeneration control is performed in the released state of the LU clutch 36. In addition, GPF assisted regeneration control CNgpfa is not performed in the predetermined state FS (for example, the low gear stage of the automatic transmission 24 and the slipping state of LU clutch 36) in which the shock caused by the rotational variation of the electric motor 12m is likely to occur. Therefore, it is possible to suppress the generation of shocks caused by the rotational variation of the electric motor 12m and to regenerate GPF 58.

Further, according to the present embodiment, in the predetermined state FS in which the gear stage of the automatic transmission 24 is the low gear stage, GPF assisted regeneration control CNgpfa in the release state of LU clutch 36 is not performed. Thus, the shock-generation caused by the rotational variation of the electric motor 12m is appropriately suppressed.

Further, according to the present embodiment, in the predetermined state FS in which LU clutch 36 is in the slipped state, GPF regeneration control CNgpf is performed by fuel-cutting without assisting the electric motor 12m in rotating the engine 12e. Thus, the shock-generation caused by the rotational variation of the electric motor 12m is appropriately suppressed.

Further, according to the present embodiment, when LU clutch 36 cannot be brought into the engaged state and LU clutch 36 cannot be brought into the slipped state, GPF assisted regeneration control CNgpfa is performed in the released state of LU clutch 36. This ensures that GPF 58 can be played back appropriately.

Further, according to the present embodiment, when the hydraulic oil temperature THfld is less than the predetermined low oil temperature THfldlow, LU clutch 36 cannot be engaged. When the hydraulic oil temperature THfld is lower than the predetermined high oil temperature THfldhi, LU clutch 36 cannot be slipped. Thus, at the time of GPF regeneration control CNgpf, the controllable control state of LU clutch 36 is appropriately determined, and GPF 58 is appropriately regenerated in accordance with the determined control state of LU clutch 36.

Although the examples of the present disclosure have been described in detail with reference to the drawings, the present disclosure also applies to other modes.

For example, in the previous embodiments, the flow chart of FIG. 2 may not include S20 and S30, or may not include S60. Even in this manner, it is possible to achieve both the suppression of the generation of shocks caused by the rotational variation of the electric motor 12m and the regeneration of GPF 58.

Further, in the above-described embodiment, a planetary gear type automatic transmission is exemplified as the automatic transmission 24, but the present disclosure is not limited to this embodiment. For example, the automatic transmission 24 may be a known belt-type continuously variable transmission or the like.

Further, in the above-described embodiment, the present disclosure can be applied to vehicles including an engine 12e, an electric motor 12m, a torque converter 22, an LU clutch 36, and a GPF 58. As the fluid transmission device, another fluid transmission device such as a fluid coupling may be used instead of the torque converter 22. As the engine 12e, for example, a diesel engine or the like may be used instead of the gasoline engine. When the engine 12e is a diesel engine, filters for collecting PM are DPF (Diesel Particulate Filter).

It should be noted that the embodiment described above is merely one embodiment, and the present disclosure can be implemented in a mode in which various changes and improvements are made based on the knowledge of those skilled in the art.

What is claimed is:

1. A control device for a vehicle including a power source including an engine and an electric motor, a fluid transmission device provided in a power transmission path between the power source and a drive wheel, a direct coupling clutch that couples an input member and an output member of the fluid transmission device, and a filter that collects particulate matter contained in exhaust gas of the engine, the control device comprising a regeneration control unit configured to:
when a request is made for regeneration control for regenerating the filter to burn and remove the particulate matter collected on the filter by a fuel cut for stopping fuel supply to the engine, perform the regeneration control in an engaged state of the direct coupling clutch; and
when the request is made for the regeneration control and the engaged state of the direct coupling clutch is not achievable, perform the regeneration control while rotation of the engine is assisted by the electric motor in a disengaged state of the direct coupling clutch, wherein
the regeneration control unit is configured not to perform the regeneration control involving rotation assistance for the engine by the electric motor in a predetermined state in which a shock due to a rotation fluctuation of the electric motor is likely to occur.

2. The control device for the vehicle according to claim 1, wherein:
the vehicle further includes a transmission provided in a power transmission path between the fluid transmission device and the drive wheel; and
the regeneration control unit is configured not to perform the regeneration control in the disengaged state of the direct coupling clutch and in the predetermined state in which a gear ratio of the transmission is a gear ratio on a low vehicle speed side.

3. The control device for the vehicle according to claim 1, wherein the regeneration control unit is configured to, when a slip state of the direct coupling clutch is achievable, perform the regeneration control without the rotation assistance for the engine by the electric motor in the predetermined state in which the direct coupling clutch is in the slip state.

4. The control device for the vehicle according to claim 3, wherein the regeneration control unit is configured to perform the regeneration control in the disengaged state of the direct coupling clutch when the engaged state of the direct coupling clutch is not achievable and the slip state of the direct coupling clutch is not achievable.

5. The control device for the vehicle according to claim 4, wherein:
the engaged state of the direct coupling clutch is not achievable when a temperature of hydraulic oil supplied to the direct coupling clutch is lower than a predetermined low oil temperature that is a lower limit value at which controllability of the engaged state is securable; and
the slip state of the direct coupling clutch is not achievable when the temperature of the hydraulic oil is lower than a predetermined high oil temperature that is higher than the predetermined low oil temperature and is a lower limit value at which controllability of the slip state is securable.
